(19) United States
(12) Patent Application Publication
(10) Pub. No.: US 2008/0045245 A1
(43) Pub. Date: Feb. 21, 2008

(54) Locating people and routes on a digital map

(75) Inventors: James A. Billmaier, Woodinville, WA (US); David A. Billmaier, Woodinville, WA (US); John M. Kellum, Woodinville, WA (US)

Correspondence Address: FSP LLC, P.O. BOX 890, VANCOUVER, WA, 98666, US

(73) Assignee: Patent Navigation Inc., Woodinville, WA (US)

(21) Appl. No.: 11/893,952

(22) Filed: Aug. 17, 2007

Related U.S. Application Data
(60) Provisional application No. 60/838,688, filed on Aug. 18, 2006.

(51) Int. Cl. H04Q 7/20

(52) U.S. Cl. 455/457

(57) ABSTRACT

Generating a map may include and/or involve detecting a location of a mobile wireless device associated with a first person, communicating information about the location of the wireless device to a network location where the information is applied to identify the location on a map, and communicating the map via the network to a second person associated with the first person.

### PRIORITY

Priority is claimed to United States provisional patent application LOCATING PEOPLE AND ROUTES ON A DIGITAL MAP, having application No. 60/838688, filed on Friday, Aug. 18, 2006.

### TECHNICAL FIELD

The present disclosure relates to mapping and determining the location of wireless devices.

### BACKGROUND

It is now possible using various technologies to locate with some accuracy the location of an active wireless device, such as a cell phone or GPS transmitter. It is also possible to retrieve digital maps from the Internet or other network sources.

People may wish to know the location of other people with whom they are associated, or may wish to know if their family/friends/associates are in the vicinity of an area of interest.

### SUMMARY

The following summary is intended to highlight and introduce some aspects of the disclosed embodiments, but not to limit the scope of the claims. Thereafter, a detailed description of illustrated embodiments is presented, which will permit one skilled in the relevant art to make and use various embodiments.

Generating a map may include and/or involve detecting a location of a mobile wireless device associated with a first person, communicating information about the location of the wireless device to a network location where the information is applied to identify the location on a map, and communicating the map via the network to a second person associated with the first person.

The second person may be authenticated to a provider of the map, and the first person identified as a friend, relative, or associate of the second person. An icon and/or color may be chosen to represent the first person's location on the map, at least in part according to a relationship of the first and second persons.

Locating the person may involve detecting the approximate location of an RF or GPS transmitter carried by the person. A map including the location may be retrieved from a network map server, and the person's location provided as an overlay onto the retrieved map.

Determining a person's route may include and/or involve detecting the mobile device at different multiple locations.

The route may be determined based at least in part on a first and second location of the mobile device. The route of travel may be identified on the map provided to the second person.

Based at least in part on the location of the wireless device and on historical travel patterns of the first person, a likely route of the first person may be determined. This may include and/or involve determining, based at least in part on the location of the wireless device and on a date, day of the week, and/or time of day, a likely route of the first person.

Based at least in part on a first and second location of the mobile device, a speed of travel of the first person and an estimated time of arrival at a predicted destination may be determined.

Identifying on the map a predicted route and destination of the first person may include and/or involve identifying the predicted route and destination at least in part according to historical behavior and/or travel patterns of the first person.

Other system/method/apparatus aspects are described in the text (e.g., detailed description and claims) and drawings forming the present application.

### BRIEF DESCRIPTION OF THE DRAWINGS

In the drawings, the same reference numbers and acronyms identify elements or acts with the same or similar functionality for ease of understanding and convenience. To easily identify the discussion of any particular element or act, the most significant digit or digits, in a reference number refer to the figure number in which that element is first introduced.

FIG. 1 is a block diagram of an embodiment of a environment for which a map may be produced including the location of people and/or route information.

FIG. 2 is an action flow diagram of an embodiment of a process of providing a map including the location of people and/or route information.

### DETAILED DESCRIPTION

References to “one embodiment” or “an embodiment” do not necessarily refer to the same embodiment, although they may.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list.

“Logic” refers to signals and/or information that may be applied to influence the operation of a device. Software, hardware, and firmware are examples of logic. Hardware logic may be embodied in circuits. In general, logic may comprise combinations of software, hardware, and/or firmware.

### Environment for Which a Map May be Produced Including the Location of People and/or Route Information

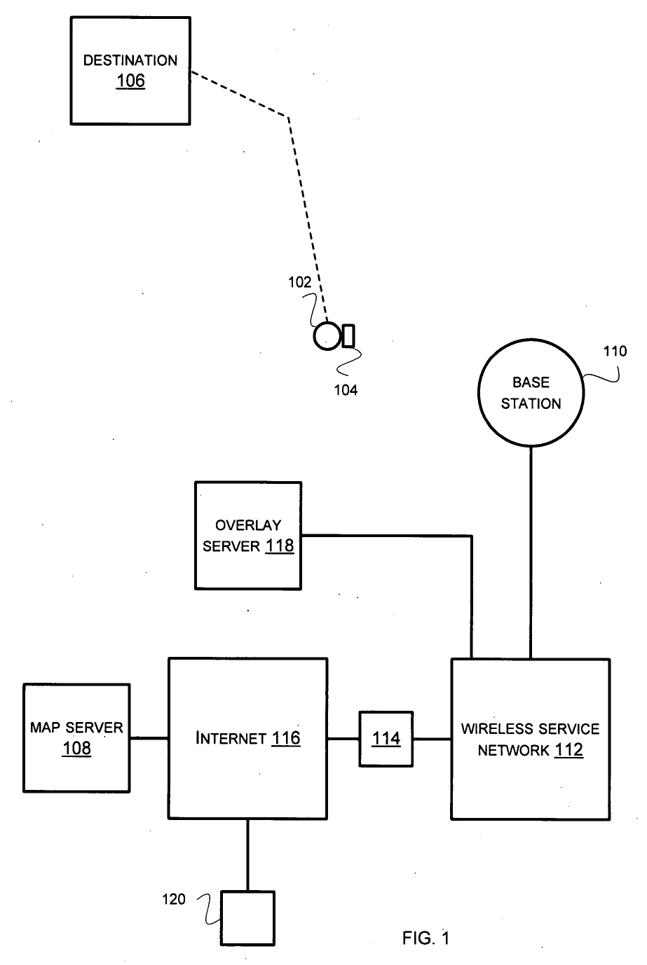

FIG. 1 is a block diagram of an embodiment of an environment for which a map may be produced, the map including the location of a person or persons and/or route information. The environment includes, but may not be limited to, a person 102, a mobile communication device 104, a destination 106, a base station 110, a wireless service network 112, and a map server 108. The environment also includes an overlay server 118, a second network 116, a gateway between the two networks 114, and access equipment for the second network 120. As shown in FIG. 1, the second network is the Internet. Other elements and/or couplings among the elements have been omitted as they would be apparent to skilled practitioners in the relevant art(s).

The person 102 is carrying or traveling with the mobile communication device 104. The mobile communication device 104 is a portable communication device having long-range wireless communication capability. For example, the mobile device may be one or more of a cell phone, satellite phone, global positioning system (GPS) enabled device, personal digital assistant (PDA), laptop (notebook) or sub-notebook computer. The mobile device 104 may be mobile by way of being installed in something which is mobile, for example, a device installed in a vehicle in which the person 102 is traveling. The destination 106 is a likely or predicted destination of the person 102, such as, for example, one or more of a home, shop, store, eating location, rest room, day care, office, or work location.

The base station 110 is a network access point for the mobile communication device 104. The wireless service network 112 is a service network for the mobile communication device 104, providing, among other things, wireless access, call routing and completion, data communication, and gateways to other networks and services such as the wireless service network—Internet gateway 114. The cellular telephone networks of Cingular, Verizon, and T-Mobile are examples of wireless service networks. The wireless service network—Internet gateway 114 provides data communication and addressing to the Internet 116 from the wireless service network 112, and vice versa. The Internet 116 comprises the equipment and interconnections of the global Internet or a region thereof. The Internet access equipment 120 is equipment for interfacing and accessing the Internet 116, or a region thereof. Internet access equipment 120 may comprise one or more of a personal computer, portable computer, PDA, cell phone, or Internet-enabled television.

The map server 108 is a device or devices, accessible over a network, that stores and/or generates map information for one or more geographic areas. For example, the map server may be one or more server computers of a local area network (LAN), intranet, and/or the Internet. The ‘Intranet’ refers to facility-wide network. The overlay server 118 provides overlay information for maps provided by the map server 108. The overlay information may include location and/or route, speed, predicted destination, and/ or estimated time of arrival (ETA) for the person 102. The overlay server 108 may include or access a relationship database. When the overlay server 108 authenticates the person who is to receive the map with overlay, it may check to see if it has location information for associates (such as person 102)of the person; and, if so, it may provide location and/or route information on the map for them. As illustrated, the overlay server 118 and the map server 108 are located on distinct devices on separate networks 112 and 116. However, in some implementations they 118 and 108 may be physically located on the same network or even be physically located on the same device.

Other examples and/or embodiments of a mobile communication device 104, a map server 108, a base station 110, a wireless service network 112, a wireless service network—Internet gateway 114, a network 116, an overlay server 118, and network access equipment 120 may be apparent to skilled practitioners in the relevant art(s).

Detecting and Mapping Locations

The location of a mobile wireless device 104 associated with a first person 102 may be detected, and information about the location of the wireless device 104 may be communicated to a network location where the information is applied to identify the location on a map. The map may be communicated via the network 112 and 116 to a second person associated with the first person 102.

Detecting a location of a mobile wireless device 104 associated with a first person 102 may involve detecting the approximate location of an RF or GPS transmitter, such as detecting the location of a cellular telephone, satellite phone, or vehicle including the RF or GPS transmitter. A map including the location may be requested from a network map server, and the location identified as an overlay onto the retrieved map. Identifying the location on a map may involve accessing a relationship database to obtain information about associates of the second person, obtaining location information when available about the associates, and providing their location information as an overlay on the retrieved map.

Authentication and Relationship Coding

Providing a map with overlay to a second person associated with the first person 102 may involve authenticating the second person to a provider of the map, and identifying the first person 102 as someone identified as a friend, relative, or associate of the second person. An icon and/or color may be selected to represent the location at least in part according to a relationship of the first 102 and second persons.

Route of Travel, Speed, Destination and ETA

A route may be inferred by detecting a mobile device 104 at multiple i.e. different locations. Based at least in part on a first and second location of the mobile device 104, a route of travel of the first person 102 may be determined and identified on the map provided to the second person. A predicted destination 106 of the first person 102 may also be determined and identified.

Providing a map with overlay may include determining, based at least in part on the location of the wireless device and on historical travel patterns of the first person 102, a likely route of the first person 102. The likely route may be based at least in part on the location of the wireless device 104 and on a date, day of the week, and/or time of day. Based at least in part on a first and second location of the mobile device 104, a speed of travel of the first person 102 and an estimated time of arrival at a predicted destination 106 may also be determined. The predicted route and destination 106 of the person 102 at least in part according to historical behavior and/or travel patterns of the person 102.

### Process of Providing a Map Including the Location of People and/or Route Information

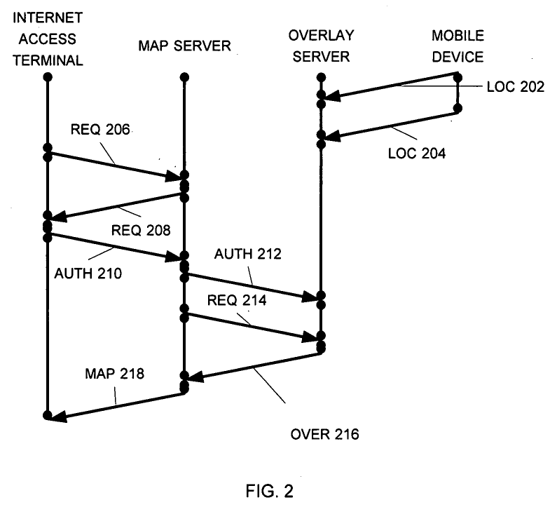

FIG. 2 is an action flow diagram of an embodiment of a process of providing a map including the location of people and/or route information. 0043 At 202 the mobile device provides location information to the overlay server. The overlay server may periodically request or receive information from various mobile devices; or, the overlay server may receive such location information only upon submitting a request in order to fulfill an overlay request. An overlay request may be from the map server.

At 204 and 206 the mobile device provides location information to the overlay server. The location of the mobile device may change, so that the location information of the mobile device may change between 204 and 206.

At 206 an Internet access terminal of a person provides a map request to the map server. At 208 the map server provides an authentication request to the Internet access terminal. The person authenticates themselves at 210 by way of the Internet access terminal providing authentication information to the map server. The person at the terminal is now authenticated to the map server.

At 212 the map server provides the person's authentication information to the overlay server. The overlay server now knows the identity of the person requesting the map, and may look up persons associated with the person at the terminal, and may determine if the location of those persons is presently available. The overlay server may use a relationship database to find associates of the person requesting the map. At 214 the map server provides an, overlay information request to the overlay server.

At 216 the overlay server provides overlay information to the map server. If the person associated with the mobile device is also associated with the person requesting the map, and if the mobile device's location is within the scope of the requested map, then an icon or other indication of the mobile device's position may appear when the overlay information is combined with the map information and displayed. If enough information is available, route and probable destination as well as estimated time of arrival may also be provided. At 218 the map server provides a map with the overlay information superimposed upon it to the Internet access terminal.

What is claimed is:

1. A method of providing, via a network, a map including locations of people of interest comprising:
detecting a location of a mobile wireless device associated with a first person;
communicating information about the location of the wireless device to a network location where the information is applied to identify the location on a map; and
communicating the map via the network to a second person associated with the first person.

2. The method of providing, via a network, a map including locations of people of interest of claim 1, wherein communicating the map via the network to a second person associated with the first person further comprises:
authenticating the second person to a provider of the map, and identifying the first person as someone identified as a friend, relative, or associate of the second person.

3. The method of providing, via a network, a map including locations of people of interest of claim 1, wherein the information about the location is applied to identify the location on a map further comprises:
selecting an icon and/or color to represent the location at least in part according to a relationship of the first and second persons.

4. The method of providing, via a network, a map including locations of people of interest of claim 1, wherein detecting a location of a mobile wireless devices associated with a first person further comprises:
detecting the approximate location of an RF or GPS transmitter.

5. The method of providing, via a network, a map including locations of people of interest of claim 4, wherein detecting the approximate location of and RF or GPS transmitter further comprises: detecting the location of a cellular telephone, satellite phone, or vehicle comprising the RF or GPS transmitter.

6. The method of providing, via a network, a map including locations of people of interest of claim 1, wherein communicating information about the location to a network location where the information about the location is applied to identify the location on a map further comprises:
requesting a map comprising the location from a network map server, and identifying the location as an overlay onto the retrieved map.

7. The method of providing, via a network, a map including locations of people of interest of claim 1, further comprising:
detecting the mobile device at a different location than before.

8. The method of providing, via a network, a map including locations of people of interest of claim 1, further comprising:
determining, based at least in part on a first and second location of the mobile device, a route of travel of the first person, and identifying the route of travel on the map provided to the second person.

9. The method of providing, via a network, a map including locations of people of interest of claim 1, further comprising:
determining, based at least in part on the location of the wireless device and on historical travel patterns of the first person, a likely route of the first person.

10. The method of providing, via a network, a map including locations of people of interest of claim 9, wherein determining, based at least in part on the location of the wireless device and on historical travel patterns of the first person, a likely route of the first person further comprises:
determining, based at least in part on the location of the wireless device and on a date, day of the week, and/or time of day, a likely route of the first person.

11. The method of providing, via a network, a map including locations of people of interest of claim 1, further comprising:
determining, based at least in part on a first and second location of the mobile device, a speed of travel of the first person and an estimated time of arrival at a predicted destination.

12. The method of providing, via a network, a map including locations of people of interest of claim 1, further comprising:
identifying on the map a predicted route and destination of the first person.

13. The method of providing, via a network, a map including locations of people of interest of claim 12, wherein identifying on the map a predicted route and destination of the first person further comprises:
identifying the predicted route and destination at least in part according to historical behavior and/or travel patterns of the first person.
